(19) United States
(12) Patent Application Publication
(10) Pub. No.: US 2013/0117252 A1
(43) Pub. Date: May 9, 2013

(54) LARGE-SCALE REAL-TIME FETCH SERVICE

(71) Applicant: Google Inc., Mountain View, CA (US)

(72) Inventors: Sumitro Samaddar, Cupertino, CA (US); Rupesh Kapoor, Palo Alto, CA (US); Pawel Alexander Fedorynski, Menlo Park, CA (US)

(73) Assignee: GOOGLE INC., Mountain View, CA (US)

(21) Appl. No.: 13/644,297

(22) Filed: Oct. 4, 2012

Related U.S. Application Data
(60) Provisional application No. 61/557,740, filed on Nov. 9, 2011.

(51) Int. Cl. G06F 17/30

(52) U.S. Cl. 707/709; 707/E17.108

(57) ABSTRACT

System and method for fetching embedded object content as part of a batch crawl. A fetch server receives a request on a request thread to retrieve content for objects embedded in a document, such as a web page. The fetch server attempts to locate the content of the object in cache first and in disk storage next. If the content is not located in the cache the fetch server may switch the request to a worker thread. If the content is not located in the disk storage, the fetch server may schedule a request to retrieve the content of the embedded object through a batch web crawl. Scheduling a request may include determining that a request to crawl the content of the object has already been scheduled or inserting a request into a scheduling queue.

### CROSS-REFERENCE TO RELATED APPLICATION

This application claims the benefit of priority to U.S. Provisional Application No. 61/557,740, filed Nov. 9, 2011, the disclosure of which is incorporated herein by reference in its entirety.

### TECHNICAL FIELD

This description relates to searching document repositories and, more specifically, to methods and systems for efficiently retrieving embedded objects for later rendering from a large document repository, such as the Internet.

### BACKGROUND

The world-wide-web is a rich source of information. Today, there are estimated to be over one trillion unique documents such as web pages. Each document has a specific address, known as a uniform resource locator (URL). Many of these documents are dynamically created, e.g., the home page of the New York Times, and have links to embedded content such as images, style sheets, and videos. To fully recreate or store these documents, for example as a web page preview, the documents must be rendered as they exist when they are first created and served. While it is relatively straightforward for a web browser to render a single web page or a small number of web pages in real time, for example as they are created, it is much more difficult for a web page storage system to render and store a large number of documents, such as all of the pages on the world wide web (1 trillion pages) or even just the top 1% of pages on the world wide web (10 billion pages) in real time.

### SUMMARY

According to one general aspect of the invention, a computer-implemented method for fetching content of an object embedded in a document includes identifying a fetch server from a plurality of fetch servers that is associated with a host of the document as part of a batch-crawl of a corpus of documents and sending a request to the fetch server for the content of the embedded object. The method may also include receiving the request at the fetch server on a request thread, determining, at the fetch server, whether a first memory storage device associated with the fetch server contains the content of the object, and returning the content from the first memory storage device when it is determined that the first storage device contains the content. When it is determined that the first storage device does not contain the content the method may also include switching the request from the request thread to a worker thread, determining whether a second memory storage device contains the content of the object, wherein the second memory storage device has a slower access time that the first memory storage device, and returning the content from the second memory storage device when it is determined that the second storage device contains the content. When the content is not in the second memory storage device the method may include scheduling a request with the batch crawler to have the content retrieved from a server hosting the embedded object.

These and other aspects can include one or more of the following features. For example, the method may also include determining whether a queue storing scheduled requests has room for another request when it is determined that the request has not been scheduled, inserting the request to have the content retrieved into the queue when it is determined that the queue has room, and returning a failure response when it is determined that the queue does not have room. In some implementations, after returning a failure response, the method may include receiving a second request for the content of the embedded object, the second request being a repeat of the first request. The second request may be sent to another fetch server from the plurality of fetch servers. As another example, scheduling the request may include determining whether a request to crawl the content has already been scheduled and returning a failure response when the request has already been scheduled. In some implementations the method can include receiving a dummy fetch request for the content of the object prior to receiving the request to fetch the content. The method may also include determining whether a timestamp associated with the content is too old and, returning the content from the first memory device may include returning the content when it is determined that the timestamp not too old.

Another aspect of the disclosure can be a system a fetch server for obtaining documents from a document corpus. The fetch server may include at least one processor, a first memory storage device, a second memory storage device that has a slower access time than the first memory storage device, and instructions embodied on a third storage device, the instructions causing the fetch server to perform operations. The operations may include receiving, on a request thread, a request to fetch content of an object embedded in a document, determining whether the first memory storage device contains the content of the object, and returning the content from the first memory storage device when it is determined that the first storage device contains the content. The operations may also include switching the request to a worker thread when the first storage device does not contain the content, determining whether the second memory storage device contains the content of the object, and returning the content from the second memory storage device when it is determined that the second storage device contains the content. The operations can also include scheduling a request to have the content retrieved from a server hosting the embedded object as part of a batch crawl when the second storage devices does not contain the content.

These and other aspects can include one or more of the following features. For example, the operations may also include determining whether a worker thread is available, performing the switching when a worker thread is available, and returning a response indicating that the request could not be processed when no worker thread is available. In some implementations the operation of scheduling the request may include determining whether a request to crawl the content has already been scheduled; and returning a failure response when the request has already been scheduled. The operations may also include determining whether a queue storing scheduled requests has room for another request when it is determined that the request has not been scheduled, inserting the request to have the content retrieved into the queue when it is determined that the queue has room, and returning a failure response when it is determined that the queue does not have room.

Another aspect of the disclosure can be a system for obtaining embedded objects from documents in a document corpus. The system may include one or more fetch servers configured to process batch fetch requests, each fetch server being associated with a host of the document corpus. Each fetch server ma include a first memory storage device, and a second memory storage device that has a slower access time than the first memory storage device. The system may also include a fetch requestor configured to determine a particular fetch server of the one or more fetch servers, the particular fetch server being associated with a host of a particular document, and send a request to the particular fetch server for content of an object embedded in the particular document. The system may also include a web crawling engine, configured to schedule batch crawls of a document corpus to retrieve object contents from the corpus. The one or more fetch servers may be configured to receive a request for a particular embedded object, determine whether the first memory storage device contains the content of the particular embedded object and return the content from the first memory storage device when it is determined that the first storage device contains the content. The one or more fetch servers may also be configured to determine whether the second memory storage device contains the content of the particular embedded object and return the content from the second memory storage device when it is determined that the second storage device contains the content. When it is determined that the second memory storage devices does not contain the content the one or more fetch servers may be configured to send a request to the web crawling engine to retrieve the object content from the corpus.

In some implementations, processing the request may include sending the object content to the fetch requestor, the fetch requestor being configured to store the object content in a memory. The fetch requestor may also be configured to render the document from the object content returned by the fetch server. In some implementations, the fetch requestor may be configured to send a dummy fetch request for the embedded object prior to requesting the content of the embedded object and, the one or more fetch servers may be configured to skip sending the object content to the fetch requestor for the dummy request. The one or more fetch servers may be further configured to determine whether a queue storing scheduled requests has room for another request when it is determined that the request has not been scheduled, insert the request to have the content retrieved into the queue when it is determined that the queue has room, and return a failure response to the fetch requestor when it is determined that the queue does not have room. In some implementations, the one or more fetch servers are further configured with a request thread and a working thread, wherein the request thread determines whether the first memory storage device contains the content of the object and the working thread determines whether the second memory storage deice contains the content of the object and sends the request to the web crawling engine. The fetch servers may be configured to switch the request from the request thread to the working thread when it is determined that the first memory device does not contain the content.

Another aspect of the disclosure can be a tangible computer-readable storage device having recorded and embodied thereon instructions that, when executed by one or more processors of a computer system, cause the computer system to perform any of the methods or operations described herein.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a document having embedded objects.

FIG. 2 is a block diagram of a system for fetching embedded objects from document content.

FIG. 3 is a flowchart illustrating a method by which a fetch server in a web page storage system can obtain target embedded objects.

FIG. 4 is a flowchart illustrating a method by which a fetch server in a web page storage system can schedule a web crawl for a target embedded object.

### DETAILED DESCRIPTION

To completely render a received document, a rendering system first obtains the content of all of the external resources that may be embedded in the web page. Such resources may include, but are not limited to, external images, JavaScript code, and style sheets. Often, the same external resource is embedded in many different web pages. For example, the New York Times logo may be located on many web pages available from the New York Times server. Additionally, JavaScript code and/or style sheets may be embedded on each web page hosted by the New York Times server. Whenever any one of these web pages is rendered, the image, JavaScript, and style sheet objects are downloaded from the New York Times server. While it is efficient for a single user's web browser to request an external web page resource, such as the logo or a style sheet, in real time, such as when the page in which the resource is embedded is rendered, it is neither feasible nor efficient for the rendering engine of a web page storage process to do so.

A render server of a web page storage process is designed to render and store a large number of documents at a time, and to continually render a large number of documents at a time in order to build a large index or repository of documents, such as web pages. If such a rendering engine attempted to render thousands or tens of thousands of web pages that embed the same external resource at the same time or close together in time, the server on which the external resource resides would be flooded with near simultaneous requests for the same object. To avoid such problems, the rendering engine of a web page storage process should ideally crawl each embedded resource exactly once, regardless of how many web pages embed the resource.

A web page storage service can render web content with embedded objects at a large scale using a plurality of render server tasks. In order to render a document, a render server task needs the contents of the document itself, e.g., http://www.cnn.com/, as well as the contents of the embedded objects, e.g., css, JavaScript, and images. At a large scale, the render servers may not directly crawl these URLs on-demand in order to honor robots.txt, host load limits, transient errors, duplicates, etc. Accordingly, an embedded object processor may be used to crawl the URLs efficiently and pass the results back to the requesting render server. In some instances, iterative calls may be needed to obtain the various levels of embedded objects. A batch crawl mechanism may be employed to address these concerns. However, a batch crawl may incur long latency times, prohibiting the timely accumulation of web page content data and limiting the number of web pages that the system can render and store.

Disclosed embodiments provide an improved distributed fetch service that provides efficient, near real-time access to URL contents. The service may cache crawled contents in main memory, such as RAM, cache, or flash memory, as well as in more persistent memory structures, such as disks. The copies in main memory may become stale after a predetermined amount of time, but until they become stale, copies of embedded objects can be quickly fetched from the main memory store rather from the slower disk store. The use of such a system provides lower latency and greater efficiency in rendering snapshots of a large number of web pages, for example 300 million per day.

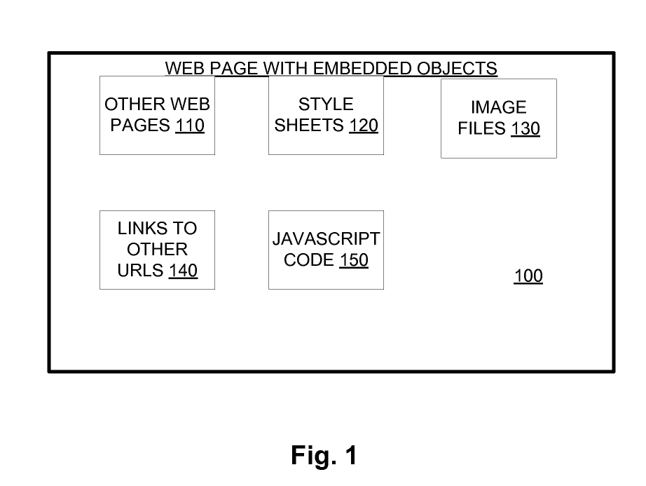

FIG. 1 is a block diagram of a document, such as a web page, having embedded objects. As shown in the figure, a web page 100 can contain a plurality of embedded objects. These embedded objects can include, but are not limited to, other web pages or documents 110, style sheets 120, image files 130, links to additional URLs 140, and JavaScript code 150. Additional and different types of embedded objects are, of course, possible. Moreover, each of the objects embedded in web page 100 may also embed other objects. For example, a web page 110 that is embedded in web page 100 may embed other web pages, image files, style sheets, and the like. Likewise, a style sheet 120 embedded in web page 100 may embed other objects such as a background image file. Further, each of the objects embedded in web page 110 or style sheet 120 may themselves embed even more objects. To completely render such a web page to an image file, a rendering engine or an embedded object processor must request each of the embedded objects 110-150, or primary embedded objects, all of the objects that are embedded in the primary embedded objects 110-150, or secondary embedded objects, all of the objects that are embedded in the secondary embedded objects, or tertiary embedded objects, and so on.

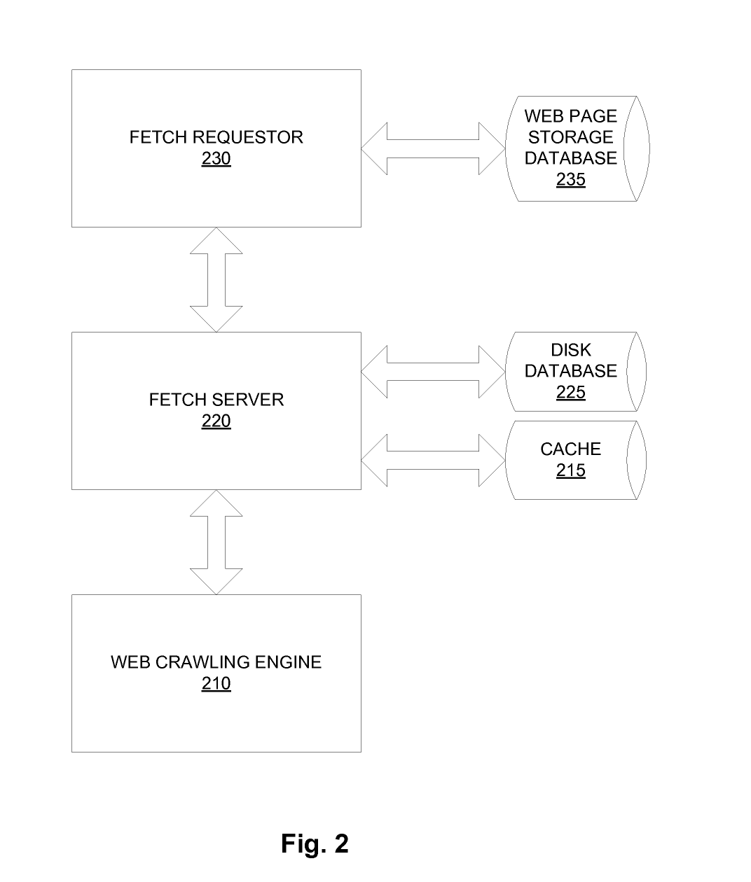

As discussed above, while an individual user's web browser can efficiently request all of these embedded objects and use them to completely render and display web page 100 in real time, the rendering engine or embedded object processor of a web page storage system cannot request all of these embedded objects in real time without the risk of flooding, and perhaps even crashing, web servers on which some of the more commonly embedded objects reside. Additionally, the time required to crawl the hundreds of millions of web pages on the world wide web is prohibitive and lag times resulting from requests to re-fetch commonly embedded objects may result in the inability to fetch and render additional web pages. A web storage system may use a batch crawler to schedule crawls to reduce the number of multiple fetches of the same content. However, objects embedded in web page content are often not fetched in the same batch as the web page content itself, causing more latency delays as the web storage system waits to fetch the embedded objects. Thus, to safely and efficiently fetch and store the data needed to render a large number of crawled web pages, a web page fetching and storage system, such as that disclosed in FIG. 2, can be employed.

FIG. 2 is a block diagram of a system for fetching embedded objects from web page content. As shown in FIG. 2, the system includes one or more web crawling engines 210. Web crawling engine 210 may be a batch crawler with an associated host queue (not shown). Web crawling engine 210 may have a queue for each host. The system may also include one or more fetch servers 220 with associated databases 215 and 225, and a fetch requestor 230 with associated database 235. Web-crawling engine 210, fetch server 220, and fetch requestor 230 may work together to safely and efficiently capture a large corpus of documents, such as web pages that can be found on the world wide web. Fetch server 220 offers a single service that may receive a list of embedded links (fetch targets) for a document from the fetch requestor 230 and respond with the contents of the embedded links. Fetch Server 220 may receive the contents of the embedded links from disk database 225, cache 215, or web crawling engine 210. Cache 215 may include a sub-set of the information stored in disk database 225. Information stored in cache 215 may become old or stale sooner than the information in disk database 225. In other words, document contents may have a shorter life in cache 215 than in database 225. Each fetch server 220 may service one or more hosts. Fetch requestor 230 may use a fetch client application programming interface to assist in choosing which fetch server 220 to send a request to. For example, a fetch client of fetch requestor 230 may use an affinity mechanism to identify a particular fetch server 220 that is most likely to have the requested URLs in its cache, e.g., the fetch server 220 that owns the host of the main document. Fetch requestor 230 may then direct a request to that particular fetch server 220.

The affinity mechanism may enable the web page storage system to avoid having multiple queues for any host by using separate fetch service tasks for each host. Thus, in certain embodiments the web storage system may include several fetch servers 220, with each fetch server 220 associated with a host. When the fetch requestor 230 makes a fetch request, the fetch client may enable it to choose the fetch server 220 that “owns” that host. This allows the system to avoid sending requests directed to one host from multiple fetch servers 220.

Because a web page has layers of embedded links, the page must be rendered iteratively, i.e., in peels. In each peel the fetch requestor 230, which may include a render server or an embedded object processor, may send a request to the fetch server 220 for known embedded links of a document, such as a web page. Once the fetch server 220 returns the content of the requested links, the fetch requestor 230 may discover a new set of embedded links in the returned content. Accordingly, the fetch requestor 230 may send a new fetch request for the newly discovered links. This loop terminates when the fetch requestor fails to discover new links in a peel.

In some embodiments, the fetch requestor 230 may pre-warm the cache 215 with the contents of currently known embedded links by making a dummy request for the links. The fetch server 220 may not send back a response for a dummy request, but will fetch the links from database 225 into cache 215. This enables a subsequent request for these links by the fetch requestor 230 to be serviced by the fetch server 220 very quickly. Such pre-warming of the cache may be especially helpful when the fetch requestor 230 is a render server where data structures use more memory than the contents of embedded links and pausing rendering while waiting for a response from a fetch server affects the use of RAM.

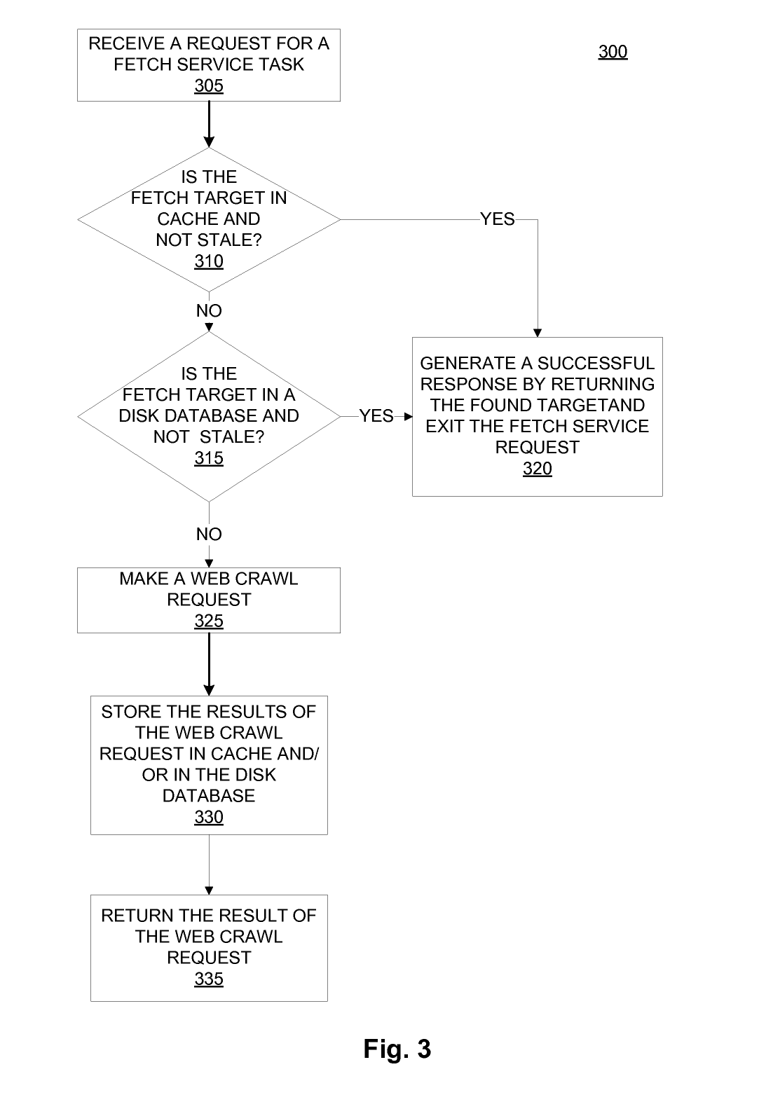

FIG. 3 is a flowchart illustrating a method by which a fetch server in a web page storage system can efficiently retrieve web page content, including embedded objects. As shown in FIG. 3, in one implementation, a fetch server 220 receives a request for a fetch service task from a fetch requestor 230 (305). Fetch requestor 230 may be a render server or an embedded object processor and the fetch service task may be a request to fetch one or more embedded objects from a specific URL. The fetch server 220 may then check to see if the fetch target is located in cache 215. Cache 215 may be RAM or flash storage, so retrieval occurs more quickly than with other types of storage. Cache 215 may be populated with embedded content that has recently been retrieved by web crawling engine 210. As explained above, in some embodiments the fetch requestor 230 may pre-warm the cache 215 to increase the number of requested fetch targets in the cache. The time that the embedded content was retrieved and last accessed may be stored in cache 215 to help determine staleness. If the fetch target is located in the cache and is not stale (i.e., the time that embedded content was last accessed and/or last retrieved is not too old) (310, YES), then the fetch server 220 may generate a successful response and return the content associated with the fetch target (320). If the fetch target is not in cache, or if the version in the cache is stale (310, NO), then fetch server 220 may look in a disk database, for example disk database 225, for the fetch target. If the fetch target is in the disk database and is not stale (315, YES), then fetch server 220 may generate a successful response for the fetch target by, for example, returning the content associated with the target from the disk database (320). In one implementation, when the fetch server 220 locates a fetch target in the disk database, or in the cache, it may update a time last accessed associated with the content of the target.

If the fetch target is not in the disk database or is located in the database but is stale (i.e. too old) (315, NO), then fetch server 220 may make a web crawl request to web crawling engine 210 (325). In some implementations, web crawling engine 210 may be a batch crawler that schedules crawl requests for specific content. In other implementations, the web crawling engine 210 may be a web crawler that processes the request as it is received. Fetch server 220 may receive the results of the web crawl request and, when the store the results in cache 215 and/or disk database 225 (330). In some instances, a successful request may include a response that indicates the link could not be resolved. In such circumstances, a successful request indicates only that the crawl status of a link is known, not that the content of link has been successfully obtained. In some embodiments, storing the results in cache 215 and/or disk database 225 may include setting a timestamp.

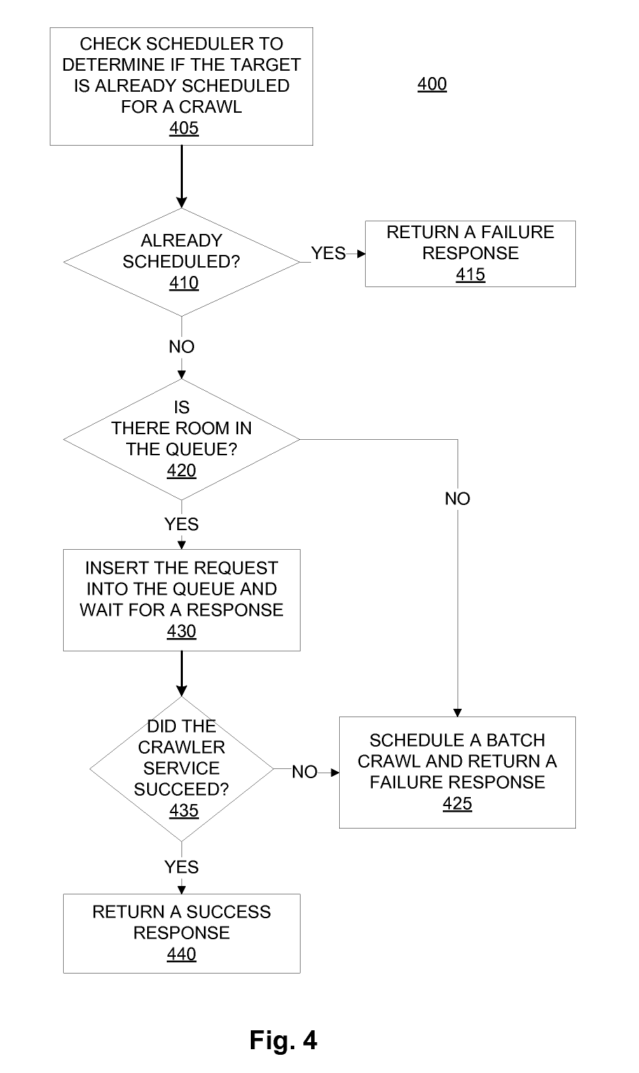

Finally, fetch server 220 may return the result of the web crawl request, whether it is successful or not successful (335) to fetch requestor 230. As explained below with regard to FIG. 4, an unsuccessful fetch request may indicate that the crawl has not yet been completed. If fetch server 220 returns an unsuccessful response, in some embodiments fetch requestor 230 may attempt the fetch again at a later time by repeating the request. If fetch requestor 230 receives the content of the object, fetch requestor 230 may store the contents in database 235 so that the document can be rendered at a later time from database 235.

The fetch server 220 may send a response back for each fetch target it receives, or it may receive a request having several embedded links (fetch targets) and send a response to fetch requestor 230 only once a response is determined for each embedded link. For a request to fetch server 220 containing multiple embedded links, fetch server 220 may perform method 300 for each link before returning a response.

In some embodiments the fetch server 220 may maintain two thread pools to do its work: a request thread pool and a worker thread pool. The threads in a request thread pool may manage the request, containing multiple URLs, as a whole. The threads in the request thread pool may also look for the content of a specific URL in cache 215. As this is relatively lightweight work, fetch server 220 may not delegate these requests to the worker thread to avoid the overhead of a thread context switch. In some embodiments, to minimize the possibility of a mutually exclusive contention accessing the in-memory cache 215, the cache 215 may be sharded or divided into multiple caches.

The second thread pool may include a worker thread pool. The request thread pool may switch the request to the worker thread pool when a document is not found in the cache 215. The threads in a worker thread pool may look for the contents of a URL in the disk database 225 or from a web crawl. Web crawl requests may be subject to a timeout, to avoid holding up the request from fetch requestor 230 indefinitely. However, a disk database request may not timeout because such requests have a much smaller latency time and prematurely timing out may result in an unnecessary web crawler request. The two thread-pool design allows fetch server 220 to more easily determine when to push back on client requests due to a lack of thread resources.

As discussed above, the fetch requestor 230 may include a fetch client. The fetch client may perform two important duties. The first is routing fetch requests to the fetch server 220 that “owns” the host for the document. The fetch client may accomplish this by using an affinity based load balancing, using a hash based on the host of the document, such as a web page, having the embedded objects. In some implementations, routing may be based on domain instead of host. For large domains, the fetch client may smear the hash a little to spread around the load into more than one fetch server 220.

The second duty performed by the fetch client may include resending a fetch request in case of push back from fetch server 220. Fetch server 220 may push back when it is heavily loaded and doesn't have any available threads in the request thread pool. The push back can be just a special reply status. The fetch client may then retry the fetch request with the next fetch server in the hash sequence of that document i.e., the hash obtained by appending the retry number to the URL string of the document. After a few retries, fetch client may add a delay or sleep between retries.

FIG. 4 is a flowchart illustrating a method by which a fetch server 220 in a web page storage system can schedule a web crawl for a target embedded object. Fetch server 220 may use method 400 when a fetch target is not found in cache 215 or database 225, as shown in step 325 of FIG. 3. As shown in FIG. 4, the fetch server 220 may check the batch crawl scheduler to determine whether the fetch target is already scheduled for a crawl (405). If a crawl of the object has already been scheduled (410, YES), then a failure response is returned. The failure response indicates that the document cannot be rendered yet because the fetch target has not yet been retrieved. This is not a permanent failure status because the target is scheduled for batch crawl and, after it is successfully crawled, the web page storage system can attempt to fetch the target again.

If the fetch target is not already scheduled (410, NO), the fetch server 220 may determine whether there is room in the crawler queue for this target. In some embodiments such queues are per host, so the queue for load-bound hosts may be full. In some embodiments the queues may be maintained in the fetch server 220 itself. If no room is available (420, NO), then fetch server 220 returns a failure response (425). As before, this response means only that the contents of the target have not yet been fetched and the fetch requestor 230 should repeat the request. Fetch server 220 may also schedule a batch crawl of the fetch target. This may include scheduling the crawl on another host or waiting until the queue has room. If, however, the queue has room (420, YES), then fetch server 220 inserts the request into the queue and waits for a response (430).

When a response is received, fetch server 220 determines whether the crawler 210 succeeded in reaching the web host for the target. If the web host was reached (435, YES), then the target has been successfully fetched. Note that even if an error was encountered and the content of the target could not be crawled, this is still considered a success. Success means that the crawl status of the fetch target has been determined, not that the content of the target was successfully located. If the crawler 210 did not successfully reach the host (435, NO), then fetch server 220 schedules a batch crawl and returns a failure response. As before, this indicates that the web storage system will reattempt to resolve the target. Process 400 then ends, with fetch server 220 supplying either a failure or a success response to fetch requestor 230. As indicated above, a success response may include sending the contents of the target object to fetch requestor 230. In some embodiments, the contents may include an indication that the object is not available. Fetch requestor 230 may store the returned contents in database 235.

The data stored in web page storage database 235 may be used to generate a preview of a web page, for example, as part of a search result. Such a preview system may provide a graphic overview of a search result and may highlight the most relevant section of the preview image. This may enable a user viewing the preview to more easily locate the right page. In some embodiments, a magnifying glass or some other icon may appear next to the title of a search result, indicating that a preview is available for the search result. Clicking on the icon may cause the system to read the data from storage database 235 and generate a visual overview of the web page. The visual overview may have search terms identified, for example with highlighting or different colored text, so that relevant content is quickly located. Because the terms are located in the context of the entire web page, a user may more easily evaluate whether the web page is relevant to the search. In addition, previews help a user determine if the search result contains a chart, map, picture, or some other embedded content. For users desiring to locate a previously visited web page, previews assist the user in determining whether the search result “looks familiar.” A preview may also assist users looking for “official websites” by displaying the trademarks and logos associated with each page.

The methods and apparatus described herein may be implemented in digital electronic circuitry, or in computer hardware, firmware, software, or in combinations of them. They may be implemented as a computer program product, i.e., as a computer program tangibly embodied in a machine-readable storage device for execution by, or to control the operation of, a processor, a computer, or multiple computers. Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit). The method steps may be performed in the order shown or in alternative orders.

A computer program, such as the computer program(s) described above, can be written in any form of programming language, including compiled or interpreted languages, and can be deployed in any form, including as a stand-alone program or as a module, component, subroutine, plug-in or other unit suitable for use in a computing environment. A computer program can be deployed to be executed on one computer or on multiple computers at one site or distributed across multiple sites and interconnected by a communications network. Processors suitable for the execution of a computer program include, by way of example, both general and special purpose microprocessors, and any one or more processors of any kind of digital computer, including digital signal processors. Generally, a processor will receive instructions and data from a read-only memory or a random access memory or both.

Elements of a computer may include at least one processor for executing instructions and one or more memory devices for storing instructions and data. Generally, a computer may also include, or be operatively coupled to receive data from and/or transfer data to one or more mass storage devices for storing data, e.g., magnetic, magneto-optical disks, or optical disks. Machine readable media suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, the methods and apparatus may be implemented on a computer having a display device, e.g., a cathode ray tube (CRT) or liquid crystal display (LCD) monitor, for displaying information to the user and a keyboard and a pointing device, e.g., a mouse, trackball or touch pad, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The methods and apparatus described may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer-implemented method for fetching content of an object embedded in a document, the method comprising:
identifying a fetch server from a plurality of fetch servers that is associated with a host of the document as part of a batch-crawl of a corpus of documents;
sending a request to the fetch server for the content of the embedded object;
receiving the request at the fetch server on a request thread;
determining, at the fetch server, whether a first memory storage device associated with the fetch server contains the content of the object;
returning the content from the first memory storage device when it is determined that the first storage device contains the content;
switching the request from the request thread to a worker thread when it is determined that the first storage device does not contain the content;
determining whether a second memory storage device contains the content of the object, wherein the second memory storage device has a slower access time that the first memory storage device;
returning the content from the second memory storage device when it is determined that the second storage device contains the content; and
scheduling a request with the batch crawler to have the content retrieved from a server hosting the embedded object when the content is not in the second memory storage device.

2. The computer-implemented method of claim 1, further comprising:
determining whether a queue storing scheduled requests has room for another request when it is determined that the request has not been scheduled;
inserting the request to have the content retrieved into the queue when it is determined that the queue has room; and
returning a failure response when it is determined that the queue does not have MOM.

3. The computer-implemented method of claim 2, further comprising:
after returning a failure response, receiving a second request for the content of the embedded object, the second request being a repeat of the first request.

4. The computer-implemented method of claim 3, wherein the second request is sent to another fetch server from the plurality of fetch servers.

5. The computer-implemented method of claim 1, wherein scheduling the request comprises:
determining whether a request to crawl the content has already been scheduled; and
returning a failure response when the request has already been scheduled.

6. The computer-implemented method of claim 1, further comprising:
receiving a dummy fetch request for the content of the object prior to receiving the request to fetch the content.

7. The computer-implemented method of claim 1, further comprising determining whether a timestamp associated with the content is too old and, wherein the returning the content from the first memory device further comprises returning the content when it is determined that the timestamp not too old.

8. A computer-readable device storing instructions that, when executed by one or more processors, cause the one or more processors to perform the method of claim 1.

9. A fetch server for obtaining documents from a document corpus, the fetch server comprising:
at least one processor;
a first memory storage device;
a second memory storage device that has a slower access time than the first memory storage device;
instructions embodied on a third storage device, the instructions causing the fetch server to perform operations comprising:
receiving, on a request thread, a request to fetch content of an object embedded in a document,
determining whether the first memory storage device contains the content of the object,
returning the content from the first memory storage device when it is determined that the first storage device contains the content,
switching the request to a worker thread when the first storage device does not contain the content;
determining whether the second memory storage device contains the content of the object,
returning the content from the second memory storage device when it is determined that the second storage device contains the content, and
scheduling a request to have the content retrieved from a server hosting the embedded object as part of a batch crawl when the second storage devices does not contain the content.

10. The fetch server of claim 9, wherein the instructions cause the fetch server to further perform operations comprising:
determining whether a worker thread is available;
performing the switching when a worker thread is available; and
returning a response indicating that the request could not be processed when no worker thread is available.

11. The fetch server of claim 9, wherein the operation of scheduling the request comprises:
determining whether a request to crawl the content has already been scheduled; and
returning a failure response when the request has already been scheduled.

12. The fetch server of claim 11, the operations further comprising:
determining whether a queue storing scheduled requests has room for another request when it is determined that the request has not been scheduled;
inserting the request to have the content retrieved into the queue when it is determined that the queue has room; and
returning a failure response when it is determined that the queue does not have MOM.

13. A system for obtaining embedded objects from documents in a document corpus, the system comprising:
one or more fetch servers configured to process batch fetch requests, each fetch server being associated with a host of the document corpus and each fetch server comprising:
a first memory storage device, and
a second memory storage device that has a slower access time than the first memory storage device;
a fetch requestor configured to:
determine a particular fetch server of the one or more fetch servers, the particular fetch server being associated with a host of a particular document, and
send a request to the particular fetch server for content of an object embedded in the particular document; and
a web crawling engine, configured to schedule batch crawls of a document corpus to retrieve object contents from the corpus,
wherein the one or more fetch servers are configured to:
receive a request for a particular embedded object;
determine whether the first memory storage device contains the content of the particular embedded object,
return the content from the first memory storage device when it is determined that the first storage device contains the content,
determine whether the second memory storage device contains the content of the particular embedded object,
return the content from the second memory storage device when it is determined that the second storage device contains the content, and
send a request to the web crawling engine to retrieve the object content from the corpus when it is determined that the second memory storage devices does not contain the content.

14. The system of claim 13, wherein processing the request further comprises sending the object content to the fetch requestor, and wherein the fetch requestor is further configured to store the object content in a memory.

15. The system of claim 14, wherein the fetch requestor is further configured to render the document from the object content returned by the fetch server.

16. The system of claim 14, wherein the fetch requestor is further configured to send a dummy fetch request for the embedded object prior to requesting the content of the embedded object and, wherein the one or more fetch servers are configured to skip sending the object content to the fetch requestor for the dummy request.

17. The system of claim 13, wherein as part of sending a request to the web crawling engine, the one or more fetch servers are configured to:
determine whether a request to crawl the content has already been scheduled; and
return a failure response to the fetch requestor when the request has already been scheduled.

18. The system of claim 17, wherein the one or more fetch servers are further configured to:
determine whether a queue storing scheduled requests has room for another request when it is determined that the request has not been scheduled;
insert the request to have the content retrieved into the queue when it is determined that the queue has room; and
return a failure response to the fetch requestor when it is determined that the queue does not have room.

19. The system of claim 13, wherein the one or more fetch servers are further configured with a request thread and a working thread, wherein the request thread determines whether the first memory storage device contains the content of the object and the working thread determines whether the second memory storage deice contains the content of the object and sends the request to the web crawling engine.

20. The system of claim 19, wherein the one or more fetch servers are further configured to switch the request from the request thread to the working thread when it is determined that the first memory device does not contain the content.
